(19) United States
(12) Patent Application Publication
(10) Pub. No.: US 2007/0286793 A1
(43) Pub. Date: Dec. 13, 2007

(54) PROCESSES FOR THE PREPARATION OF CHLORINE FROM HYDROGEN CHLORIDE AND OXYGEN

(75) Inventors: Rainer Weber, Odenthal (DE); Andreas Bulan, Langenfeld (DE); Michel Haas, Dormagen (DE); Rafael Warsitz, Essen (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,405

(22) Filed: May 23, 2007

(30) Foreign Application Priority Data
May 23, 2006 (DE) 102006024516.4

(51) Int. Cl. C01B 7/04

(52) U.S. Cl. 423/500

(57) ABSTRACT

A process is disclosed comprising: (a) reacting hydrogen chloride and oxygen to form a gas mixture comprising chlorine, water, unreacted hydrogen chloride, and unreacted oxygen; (b) cooling the gas mixture to form an aqueous solution of hydrogen chloride; (c) separating at least a portion of the aqueous solution of hydrogen chloride from the gas mixture; (d) removing at least a portion of the water from the gas mixture; and (e) subjecting the gas mixture to a gas permeation such that at least a portion of the unreacted oxygen in the gas mixture is separated to form a chlorine-rich gas stream and an oxygen-containing partial stream.

### BACKGROUND OF THE INVENTION

In the preparation of a large number of chemical reactions using chlorine and/or phosgene, for example the preparation of isocyanates or the chlorination of aromatic compounds, hydrogen chloride is obtained as a by-product. The hydrogen chloride can be converted back into chlorine by electrolysis or by oxidation with oxygen, allowing the chlorine to be used in the chemical reactions again. The oxidation of hydrogen chloride (HCl) to chlorine (Cl₂) takes place by reaction of hydrogen chloride and oxygen (O₂) according to the chemical equation:
4HCl+O₂ [symbol] Cl₂+2H₂O.

The reaction for the oxidation of hydrogen chloride can be carried out in the presence of catalysts at temperatures of approximately from 250 to 450° C. Suitable catalysts for this type of thermal reaction, which is generally known as a Deacon reaction, are described, for example, in DE 1567788 A1, EP 251731 A2, EP 936184 A2, EP 761593 A1, EP 711599 A1 and DE 10250131 A1.

As an alternative to such thermal oxidations, processes are known in which the reaction of hydrogen chloride with oxygen is activated non-thermally. Such processes are described in “W. Stiller, Nichtthermische aktivierte Chemie, Birkhäuser Verlag, Basel, Boston, 1987, p. 33-34, p. 45-49, p. 122-124, p. 138-145”. Specific embodiments are disclosed, for example, in the specifications RU 2253607, JP-A-59073405, DD-A-88309, SU 1801943 A1. Non-thermally activated reactions are understood as meaning, for example, stimulation of the reaction by any of the following: high-energy radiation, for example laser radiation or other photochemical radiation sources, UV radiation, infra-red radiation, etc., a low-temperature plasma, for example produced by electrical discharges, magnetic field stimulation, tribomechanical activation, for example stimulation by shock waves, ionizing radiation, for example gamma radiation and X-radiation, α and β rays from nuclear disintegration, high-energy electrons, protons, neutrons and heavy ions, microwave irradiation.

Oxidation is generally carried out using oxygen in the form of pure gas having an O₂ content of >98 vol. %.

A common feature of all the known processes is that the reaction of hydrogen chloride with oxygen yields a gas mixture that contains, in addition to the target product chlorine, also water, unreacted hydrogen chloride and oxygen, as well as further minor constituents such as carbon dioxide. In order to obtain pure chlorine which can be reused, the product gas mixture is cooled after the reaction to such an extent that water of reaction and hydrogen chloride condense out in the form of concentrated hydrochloric acid. The resulting hydrochloric acid is separated off and the gaseous reaction mixture that remains is freed of residual water by washing with sulfuric acid or by other methods such as drying with zeolites. The reaction gas mixture, which is then free of water, is subsequently compressed, whereby oxygen and other gas constituents remain in the gas phase and can be separated from the liquefied chlorine. Such processes for obtaining pure chlorine from gas mixtures are described, for example, in Offenlegungsschriften DE 195 35 716 A1 and DE 102 35 476 A1. The purified chlorine is then conveyed to its use, for example in the preparation of isocyanates.

A fundamental disadvantage of the above-mentioned chlorine preparation processes is the comparatively high outlay in terms of energy that is required to liquefy the chlorine gas stream.

A further particular disadvantage of the known processes consists in the losses of chlorine that result from the chlorine liquefaction, which arise when partial streams of the oxygen stream, which is conventionally fed back to the HCl oxidation and contains residual chlorine, are discarded or destroyed. Because the pure oxygen that is conventionally used is complex to prepare and therefore expensive, there is a need for an improvement to the processes.

### SUMMARY OF THE INVENTION

It has been found that the aforementioned disadvantages can be overcome if, after drying, (i.e., removal of at least a portion of the water from a gas mixture resulting from the oxidation of hydrogen chloride), the chlorine-containing gas mixture is not subjected to chlorine liquefaction, but instead, is freed of oxygen and other minor constituents via gas permeation.

The present invention relates, in general, to processes for the preparation of chlorine by thermal reaction of hydrogen chloride with oxygen using catalysts and/or by non-thermally activated reaction of hydrogen chloride with oxygen, in which the gas mixture formed in the reaction, which includes the target products chlorine and water, unreacted hydrogen chloride and unreacted oxygen, and which may further include minor constituents such as carbon dioxide and nitrogen, and optionally phosgene, is cooled in order to condense hydrochloric acid, wherein the resulting aqueous concentrated hydrochloric acid can be separated from the gas mixture, and the residues of water that remain in the gas mixture can be removed, for example by washing with concentrated sulfuric acid, and wherein the chlorine formed is separated from the gas mixture or the concentration of chlorine in the gas mixture is enriched via gas permeation.

The term “gas permeation” is generally to be understood as meaning the selective separation of components of a gas mixture via one or more membranes. Methods of gas permeation are known in principle and are described, for example, in “T. Melin, R. Rautenbach; Membranverfahren—Grundlagen der Modul—und Anlagenauslegung; 2nd Edition; Springer Verlag 2004”, Chapter 1, p. 1-17 and Chapter 14, p. 437-439 or “Ullmann, Encyclopedia of Industrial Chemistry; Seventh Release 2006; Wiley-VCH Verlag”, the entire contents of each of which are hereby incorporated herein by reference.

One embodiment of the present invention includes a process comprising: (a) reacting hydrogen chloride and oxygen to form a gas mixture comprising chlorine, water, unreacted hydrogen chloride, and unreacted oxygen, which may also contain further constituents such as carbon dioxide, nitrogen, and optionally phosgene; (b) cooling the gas mixture to form an aqueous solution of hydrogen chloride; (c) separating at least a portion of the aqueous solution of hydrogen chloride from the gas mixture; (d) removing at least a portion of the remaining water from the gas mixture; and (e) subjecting the gas mixture to a gas permeation such that at least a portion of the unreacted oxygen in the gas mixture and optionally some or all of the further constituents is/are separated to form a chlorine-rich gas stream and an oxygen-containing partial stream.

Various preferred embodiments of the present invention can further include feeding at least a portion of the oxygen-containing partial stream to the reaction of hydrogen chloride with oxygen to form the gas mixture. In various preferred embodiments of the present invention, the hydrogen chloride reacted with the oxygen to form the gas mixture can comprise a product of an isocyanate preparation process, and at least a portion of the chlorine-rich gas stream is supplied to the isocyanate preparation process. Additionally, in various preferred embodiments of the present invention, the hydrogen chloride reacted with the oxygen to form the gas mixture can comprise a product of an isocyanate preparation process, and at least a portion of the chlorine-rich gas stream is supplied to the isocyanate preparation process; and at least a portion of the oxygen-containing partial stream can be fed to the reaction of hydrogen chloride with oxygen to form the gas mixture.

### BRIEF DESCRIPTION OF THE SEVERAL VIEWS OF THE DRAWING

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a representative flowchart of a chlorine oxidation with a two-stage gas permeation according to one embodiment of the present invention; and

FIG. 2 is a diagrammatic representation of a permeation test apparatus.

### DETAILED DESCRIPTION OF THE INVENTION

As used herein, the singular terms “a” and “the” are synonymous and used interchangeably with “one or more.” Accordingly, for example, reference to “a gas” herein or in the appended claims can refer to a single gas or more than one gas. Additionally, all numerical values, unless otherwise specifically noted, are understood to be modified by the word “about.”

Processes according to various embodiments of the present invention are preferably carried out continuously, because batchwise or semi-batchwise operation, which is also included within the present invention, can be slightly more complex and/or less economically favorable than a continuous process.

The separation of components in the gas mixture via gas permeation that is carried out in the processes according to the various embodiments of the present invention is preferably carried out using membranes that operate according to the molecular sieve principle, which are described, for example, in Chapter 3.4 of T. Melin, R. Rautenbach; Membranverfahren—Grundlagen der Modul—und Anlagenauslegung; 2nd Edition; Springer Verlag 2004, p. 96-105, the entire contents of which are hereby incorporated herein by reference. Membranes that are preferably used are molecular sieve membranes comprising carbon and/or SiO₂ and/or zeolites. Though not bound by any particular theory of gas permeation kinetics, in a separation according to the molecular sieve principle, the minor components, for example, which have a smaller kinetic, i.e., Leonard-Jones, diameter than the main component chlorine, are separated (i.e., retained) due to longer retention times within the sieve.

In various preferred embodiments of the present invention, the effective pore size of a molecular sieve used in a gas permeation is 0.2 to 1 nm, more preferably 0.3 to 0.5 nm.

Gas permeation to separate oxygen and optionally minor constituents from the chlorine-containing gas mixture, can provide a very pure chlorine gas, and in addition the energy requirement for the chlorine gas purification carried out by a process according to the invention is markedly reduced as compared with the liquefaction processes known hitherto. The gas mixture obtained as a further gas stream may contain substantially oxygen and, as minor constituents, carbon dioxide and optionally nitrogen, and is substantially free of chlorine.

A gas stream which is substantially free of chlorine, as used herein, refers to a content of not more than 1 wt. % chlorine in the gas stream. In various more preferred embodiments, the oxygen-containing sidestream can have a content of not more than 1000 ppm chlorine, and most preferably not more than 100 ppm chlorine.

Gas permeation is preferably carried out using so-called carbon membranes. Suitable carbon membranes include those comprised of pyrolyzed polymers, for example pyrolyzed polymers from the group: phenolic resins, furfuryl alcohols, cellulose, polyacrylonitriles and polyimides. Such membranes are described, for example, in Chapter 2.4 of T. Melin, R. Rautenbach; Membranverfahren—Grundlagen der Modul—und Anlagenauslegung; 2nd Edition; Springer Verlag 2004, p. 47-59, the entire contents of which are hereby incorporated herein by reference.

In various preferred embodiments, gas permeation can be carried out at a pressure differential between the incoming stream and the outgoing stream (chlorine) of up to 105 hPa (100 bar), more preferably from 500 to 4·10⁴ hPa (from 0.5 to 40 bar). Particularly preferable operating pressures for the treatment of chlorine-containing gas streams include pressures of 7000 to 12,000 hPa (from 7 to 12 bar).

In various preferred embodiments, gas permeation can be carried out at a temperature of the incoming gas mixture to be separated of up to 400° C., more preferably up to 200° C., and most preferably up to 120° C.

One embodiment of the present invention includes a process for the preparation of chlorine by thermal reaction of hydrogen chloride with oxygen using catalysts and/or by non-thermal activated reaction of hydrogen chloride with oxygen, wherein the oxygen-containing side stream comprising oxygen and minor constituents is separated in a further gas permeation into a partial stream containing substantially oxygen and a partial stream containing substantially carbon dioxide. Particularly preferably, at least part of the partial stream containing substantially oxygen is fed back into the reaction of hydrogen chloride with oxygen.

In such a further gas permeation stage, polymer membranes that work according to the solution diffusion principle are preferably used. Examples of such polymer membranes are described, for example, in T. Melin, R. Rautenbach; Membranverfahren—Grundlagen der Modul—und Anlagenauslegung; 2nd Edition; Springer Verlag 2004, Chapter 14.2, p. 438-451, the entire contents of which are herein incorporated by reference. Preferred polymer membranes that can be used is such a further gas permeation are membranes comprised of polysulfone, polyimide, polyaramid, polycarbonate, cellulose acetate and polysiloxane, more preferably those comprising polydimethylsiloxane (PDMS) or polyoctylmethylsiloxane (POMS). PDMS membranes that are preferably used for the further gas permeation preferably have a crosslinked structure.

Preferred embodiments in which the oxygen is recirculated have the advantage that there is no pronounced concentration of minor components such as carbon dioxide in the system circuit, which would make it necessary to discharge a significant amount of the recirculated oxygen-containing gas stream. Such discharge leads to considerable losses of oxygen, which adversely affects the economy of the process as a whole for the preparation of chlorine by reaction of hydrogen chloride with oxygen. The preferred novel processes, on the other hand, permit maximum utilization of the oxygen that is employed, owing to the recirculation of the partial stream containing substantially oxygen.

A further preferred embodiment of a process according to the invention is characterized in that air or air enriched with oxygen is used as the oxygen source for the reaction of hydrogen chloride with oxygen, and in that the oxygen-containing side stream is optionally discarded. For example, the oxygen-containing gas mixture, optionally after preliminary purification, can be released directly into the surrounding air in a controlled manner.

A further disadvantage of most known HCl oxidisation processes is that pure oxygen having an O₂ content of in most cases at least 98 vol. % must be used in the oxidation of hydrogen chloride. With the above-mentioned variant it is possible to dispense with the use of pure oxygen.

In various preferred embodiments of the present invention, air or air enriched with oxygen can be used as the oxygen source for the reaction of hydrogen chloride with oxygen.

A process according to such embodiments of the present invention carried out using air or air enriched with oxygen has further advantages. The use of air instead of pure oxygen can eliminate a considerable cost factor, because the working-up of air is substantially less complex in technical terms, and since an increase in the oxygen content displaces the reaction equilibrium in the direction of chlorine preparation, the amount of inexpensive air or oxygen-enriched air can be increased, if necessary, without hesitation.

Furthermore, a major problem of the known Deacon processes and Deacon catalysts is the occurrence of hot-spots at the surface of the catalyst, which is very difficult to control. Overheating of the catalyst readily leads to irreversible damage, which impairs the oxidation process. Various attempts have been made to avoid such local overheating (e.g., by diluting the bulk catalyst), but have not provided satisfactory solutions. An air mixture containing, for example, up to 80% inert gases permits dilution of the feed gases (reactants) and accordingly, can also permit a controlled reaction procedure by avoiding local overheating of the catalyst. The development of heat can be inhibited by the use of air or oxygen-enriched air as opposed to pure oxygen, and consequently the useful life of the catalyst is increased (by reducing the volume-based activity of the catalyst). Furthermore, the use of inert gas components can result in better heat dissipation (absorption of heat by the inert gases), which additionally contributes to preventing hot-spots.

Although it is known in principle from the prior art that HCl oxidation using air or air enriched with oxygen is possible, such a procedure is technically and economically infeasible because of the complex and expensive working-up of the Deacon reaction products resulting from such known methods with conventionally known working-up steps. In addition, such known processes are unsuccessful because of the inadequate separation of the residual gas from the chlorine, which is an expensive valuable substance, the majority of which is lost because of a high discharge of waste gases, which the use of air or of air enriched with oxygen requires. With an inert gas content of, for example, up to 80 vol. %, it is not expedient in the known processes to recirculate the inert gases containing residual chlorine in order to recover residual chlorine, whose content in the residual gas can reach up to 10% (DE-10235476-A1). Accordingly, at least part of the purified process gas must be discarded, which means the loss of a large amount of chlorine and high destruction costs of the residual gases, and which consequently impairs the economy of the known process considerably.

The efficient working up of process gas that is provided by the various embodiments of the present invention, allow for carrying out a Deacon process using commercial oxygen of low purity or using air or air enriched with oxygen. By the use of membranes, the chlorine can successfully be separated from oxygen, optionally nitrogen and further minor components. The chlorine obtained by a process according to the invention can then be reacted according to processes known in the art, for example with carbon monoxide to give phosgene, which can be used for the preparation of MDI or TDI from MDA or TDA, respectively.

As already described above, a catalytic process known as a Deacon process is preferably employed for the initial reaction of hydrogen chloride with oxygen. In such a process, hydrogen chloride is oxidized with oxygen in an exothermic equilibrium reaction to give chlorine, with the formation of water vapour. The reaction temperature can be 150 to 500° C., and the reaction pressure can be 1 to 25 bar. Because this is an equilibrium reaction, it is preferable to work at the lowest possible temperatures at which the catalyst still exhibits sufficient activity. Furthermore, it is preferable to use oxygen in more than stoichiometric amounts. A two- to four-fold oxygen excess, for example, is preferred. Because there is no risk of selectivity losses, it can be economically advantageous to work at a relatively high pressure and accordingly with a longer dwell time compared with normal pressure.

Suitable preferred catalysts for a Deacon process contain ruthenium oxide, ruthenium chloride or other ruthenium compounds on silicon dioxide, aluminium oxide, titanium dioxide or zirconium dioxide or tin dioxide as support. Suitable catalysts can be obtained, for example, by applying ruthenium chloride to the support and then drying or drying and calcining. In addition to or instead of a ruthenium compound, suitable catalysts can also contain compounds of different noble metals, for example gold, palladium, platinum, osmium, iridium, silver, copper or rhenium. Suitable catalysts can also contain chromium(III) oxide.

The catalytic oxidation of hydrogen chloride can be carried out adiabatically or, preferably, isothermally or approximately isothermally, discontinuously, but preferably continuously, as a fluidised or fixed bed process, preferably as a fixed bed process, particularly preferably in tubular reactors on heterogeneous catalysts at a reactor temperature of 180 to 500° C., preferably 200 to 400° C., particularly preferably 220 to 350° C., and a pressure of 1 to 25 bar (from 1000 to 25,000 hPa), preferably 1.2 to 20 bar, particularly preferably 1.5 to 17 bar and especially 2.0 to 15 bar.

Suitable reaction apparatuses in which the catalytic oxidation of hydrogen chloride can be carried out include fixed bed or fluidised bed reactors. The catalytic oxidation of hydrogen chloride can preferably also be carried out in a plurality of stages.

In the case of the isothermal or approximately isothermal procedure, it is also possible to use a plurality of reactors, that is to say from 2 to 10, preferably from 2 to 6, particularly preferably from 2 to 5, especially from 2 to 3 reactors, connected in series with additional intermediate cooling. The oxygen can be added either in its entirety, together with the hydrogen chloride, upstream of the first reactor, or distributed over the various reactors. This series connection of individual reactors can also be combined in one apparatus.

A further preferred embodiment of a device suitable for use in a process according to the invention comprises using a structured bulk catalyst in which the catalytic activity increases in the direction of flow. Such structuring of the bulk catalyst can be effected by variable impregnation of the catalyst support with active substance or by variable dilution of the catalyst with an inert material. There can be used as the inert material, for example, rings, cylinders or spheres of titanium dioxide, zirconium dioxide or mixtures thereof, aluminium oxide, steatite, ceramics, glass, graphite or stainless steel. In the case of the use of catalyst shaped bodies, which is preferred, the inert material should preferably have similar outside dimensions.

Suitable catalyst shaped bodies include shaped bodies of any shape, preferred shapes being lozenges, rings, cylinders, stars, cart wheels or spheres and particularly preferred shapes being rings, cylinders or star-shaped extrudates.

Suitable heterogeneous catalysts include in particular ruthenium compounds or copper compounds on support materials, which can also be doped, with preference being given to optionally doped ruthenium catalysts. Examples of suitable support materials include silicon dioxide, graphite, titanium dioxide of rutile or anatase structure, zirconium dioxide, aluminium oxide or mixtures thereof, preferably titanium dioxide, zirconium dioxide, aluminium oxide or mixtures thereof, particularly preferably γ- or δ-aluminium oxide or tin dioxide or mixtures thereof.

The copper or ruthenium supported catalysts can be obtained, for example, by impregnating the support material with aqueous solutions of CuCl₂ or RuCl₃ and optionally of a promoter for doping, preferably in the form of their chlorides. Shaping of the catalyst can take place after or, preferably, before the impregnation of the support material.

Suitable promoters for the doping of the catalysts include alkali metals such as lithium, sodium, potassium, rubidium and caesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can then preferably be dried and optionally calcined at a temperature of from 100 to 400° C., preferably from 100 to 300° C., for example, under a nitrogen, argon or air atmosphere. The shaped bodies are preferably first dried at from 100 to 150° C. and then calcined at from 200 to 400° C.

The hydrogen chloride conversion in a single pass can preferably be limited to from 15 to 90%, preferably from 40 to 85%, particularly preferably from 50 to 70%. After separation, all or some of the unreacted hydrogen chloride can be fed back into the catalytic hydrogen chloride oxidation. The volume ratio of hydrogen chloride to oxygen at the entrance to the reactor is preferably 1:1 and 20:1, preferably 2:1 and 8:1, particularly preferably 2:1 and 5:1.

The heat of reaction of the catalytic hydrogen chloride oxidation can advantageously be used to produce high-pressure steam. This can be used to operate a phosgenation reactor and/or distillation columns, in particular isocyanate distillation columns.

The chlorine formed in the Deacon oxidation is separated from the remainder of the gas mixture by the processes according to the various embodiments of the present invention. The separation of the chlorine preferably comprises a plurality of stages, namely the separation and optional recirculation of unreacted hydrogen chloride from the product gas stream of the catalytic hydrogen chloride oxidation, drying of the resulting stream containing substantially chlorine and oxygen, and separation of chlorine from the dried stream.

The separation of unreacted hydrogen chloride and of steam that has formed can be carried out by condensing aqueous hydrochloric acid from the product gas stream of the hydrogen chloride oxidation by cooling. Hydrogen chloride can also be absorbed in dilute hydrochloric acid or water.

Further preferred embodiments of processes according to the invention are characterized in that the hydrogen chloride used as a starting material can include a product of an isocyanate preparation process, and/or in that the purified chlorine gas freed of oxygen and optionally of minor constituents can be used in a preparation of isocyanates. Particularly preferred are those embodiments in which the hydrogen chloride used as a starting material can include a product of an isocyanate preparation process, and the purified chlorine gas freed of oxygen and optionally of minor constituents can be used in the isocyanate preparation process.

A particular advantage of such a combined process is that conventional chlorine liquefaction can be dispensed with and the chlorine for recirculation into the isocyanate preparation process is available at approximately the same pressure level as the inlet stage of the isocyanate preparation process.

The combined process according to such preferred embodiments accordingly includes an integrated process for the preparation of isocyanates and the oxidation of hydrogen chloride to recover chlorine for the synthesis of phosgene as starting material for the preparation of isocyanates.

In a first step of such a preferred process, the preparation of phosgene takes place by reaction of chlorine with carbon monoxide. The synthesis of phosgene is sufficiently well known and is described, for example, in Ullmanns Enzyklopädie der industriellen Chemie, 3rd Edition, Volume 13, pages 494-500. Further processes for the preparation of isocyanates are described, for example, in U.S. Pat. No. 4,764,309 and WO 03/72237, the entire contents of each of which are incorporated herein by reference. On an industrial scale, phosgene is predominantly produced by reaction of carbon monoxide with chlorine, preferably on activated carbon as a catalyst. The strongly exothermic gas phase reaction takes place at temperatures of from at least 250° C. to not more than 600° C., generally in tubular reactors. The heat of reaction can be dissipated in various ways, for example by means of a liquid heat-exchange agent, as described, for example, in WO 03/072237, the entire contents of which are incorporated herein by reference, or by vapour cooling via a secondary cooling circuit while simultaneously using the heat of reaction to produce steam, as disclosed, for example, in U.S. Pat. No. 4,764,308, the entire contents of which are incorporated herein by reference.

In a subsequent process step of such a preferred process, at least one isocyanate is formed from the phosgene formed previously, by reaction with at least one organic amine or with a mixture of two or more amines. This process step is also referred to hereinbelow as phosgenation. The reaction takes place with the formation of hydrogen chloride as by-product.

The synthesis of isocyanates is likewise sufficiently well known from the prior art, phosgene generally being used in a stoichiometric excess, based on the amine. The phosgenation is preferably carried out in the liquid phase, it being possible for the phosgene and the amine to be dissolved in a solvent. Preferred solvents are chlorinated aromatic hydrocarbons, such as, for example, chlorobenzene, o-dichlorobenzene, p-dichlorobenzene, trichlorobenzenes, the corresponding chlorotoluenes or chloroxylenes, chloroethylbenzene, monochlorodiphenyl, α- or β-naphthyl chloride, benzoic acid ethyl ester, phthalic acid dialkyl esters, diisodiethyl phthalate, toluene and xylenes. Further examples of suitable solvents are known from the art. As is additionally known from the art, for example from WO 96/16028, the entire contents of which are incorporated herein by reference, the resulting isocyanate itself can also serve as the solvent for phosgene. In another, preferred embodiment, the phosgenation, in particular of suitable aromatic and aliphatic diamines, takes place in the gas phase, that is to say above the boiling point of the amine. Gas-phase phosgenation is described, for example, in EP 570 799 A, the entire contents of which are incorporated herein by reference. Advantages of this process over liquid-phase phosgenation, which is otherwise conventional, are the energy saving which results from the minimisation of a complex solvent and phosgene circuit.

Suitable organic amines are preferably any primary amines having one or more primary amino groups which are able to react with phosgene to form one or more isocyanates having one or more isocyanate groups. The amines have at least one, preferably two, or optionally three or more primary amino groups. Accordingly, suitable organic primary amines are aliphatic, cycloaliphatic, aliphatic-aromatic, aromatic amines, diamines and/or polyamines, such as aniline, halo-substituted phenylamines, for example 4-chlorophenylamine, 1,6-diaminohexane, 1-amino-3,3,5-trimethyl-5-amino-cyclohexane, 2,4-, 2,6-diaminotoluene or mixtures thereof, 4,4′-, 2,4′- or 2,2′-diphenylmethanediamine or mixtures thereof, as well as higher molecular weight isomeric, oligomeric or polymeric derivatives of the mentioned amines and polyamines. Further possible amines are known from the prior art. Preferred amines for the present invention are the amines of the diphenylmethanediamine group (monomeric, oligomeric and polymeric amines), 2,4-, 2,6-diaminotoluene, isophoronediamine and hexamethylenediamine. In the phosgenation, the corresponding isocyanates diisocyanatodiphenylmethane (MDI, monomeric, oligomeric and polymeric derivatives), toluoylene diisocyanate (TDI), hexamethylene diisocyanate (HDI) and isophorone diisocyanate (IPDI) are obtained.

The amines can be reacted with phosgene in a single-stage or two-stage or, optionally, a multi-stage reaction. A continuous or discontinuous procedure is possible.

If a single-stage phosgenation in the gas phase is chosen, the reaction is preferably carried out above the boiling temperature of the amine, preferably within a mean contact time of from 0.5 to 5 seconds and at temperatures of from 200 to 600° C.

In the case of phosgenation in the liquid phase, temperatures of from 20 to 240° C. and pressures of from 1 to about 50 bar are preferably used. Phosgenation in the liquid phase can be carried out in a single stage or in a plurality of stages, it being possible to use phosgene in a stoichiometric excess. The amine solution and the phosgene solution are combined via a static mixing element and then guided through one or more reaction columns, for example from bottom to top, where the mixture reacts completely to form the desired isocyanate. In addition to reaction columns provided with suitable mixing elements, reaction vessels having a stirrer device can also be used. As well as static mixing elements, it is also possible to use special dynamic mixing elements. Suitable static and dynamic mixing elements are known from the art.

In one example, continuous liquid-phase isocyanate production on an industrial scale is carried out in two stages. In the first stage, generally at temperatures of not more than 220° C., preferably not more than 160° C., the carbamoyl chloride is formed from amine and phosgene and amine hydrochloride is formed from amine and cleaved hydrogen chloride. This first stage is highly exothermic. In the second stage, both the carbamoyl chloride is cleaved to isocyanate and hydrogen chloride and the amine hydrochloride is reacted to carbamoyl chloride. The second stage is generally carried out at temperatures of at least 90° C., preferably from 100 to 240° C.

After the phosgenation, the isocyanates formed in the phosgenation are preferably separated off. This can be effected by first separating the reaction mixture of the phosgenation into a liquid and a gaseous product stream in a manner known to the person skilled in the art. The liquid product stream contains substantially the isocyanate or isocyanate mixture, the solvent and a small amount of unreacted phosgene. The gaseous product stream consists substantially of hydrogen chloride gas, phosgene in stoichiometic excess, and small amounts of solvent and inert gases, such as, for example, nitrogen and carbon monoxide. Furthermore, the liquid stream according to the isocyanate separation is then conveyed to a working up step, preferably working up by distillation, wherein phosgene and the solvent are separated off in succession. In addition, further working up of the resulting isocyanates is optionally carried out, for example by fractionating the resulting isocyanate product in a manner known to the person skilled in the art.

The hydrogen chloride obtained in the reaction of phosgene with an organic amine may contain organic constituents, which can be disruptive in further processing. These organic constituents include, for example, the solvents used in the isocyanate preparation, such as chlorobenzene, o-dichlorobenzene or p-dichlorobenzene.

The following examples are for reference and do not limit the invention described herein

### EXAMPLES

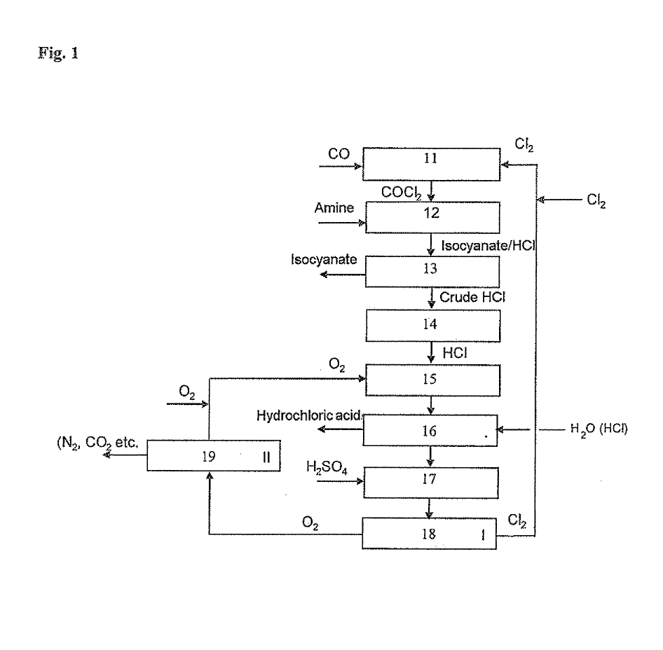

Referring to FIG. 1, in a first stage 11 of an isocyanate preparation, chlorine is reacted with carbon monoxide to give phosgene. In the following stage 12, phosgene from stage 11 is used with an amine (e.g., toluenediamine) to give an isocyanate (e.g., toluene diisocyanate, TDI) and hydrogen chloride, the isocyanate is separated off (stage 13) and utilised, and the HCl gas is subjected to purification 13. The purified HCl gas is reacted with oxygen in the HCl oxidation process 15 (e.g., in a Deacon process by means of catalyst).

The reaction mixture from 15 is cooled (step 16). Aqueous hydrochloric acid, which is optionally obtained thereby mixed with water or dilute hydrochloric acid, is discharged.

The gas mixture so obtained, consisting at least of chlorine, oxygen and minor constituents such as nitrogen, carbon dioxide, etc., and is dried with concentrated sulfuric acid (96%) (step 17).

In a first gas permeation stage 18, chlorine is separated from the gas mixture from stage 17. The residual stream containing oxygen and minor constituents is cleaned of minor constituents such as carbon dioxide in a second gas permeation stage 19.

The oxygen stream resulting from stage 19 is fed back to the HCl oxidation 15.

The chlorine gas obtained from the first gas permeation 18 can be used again directly in the phosgene synthesis 11.

In an alternative which is not shown, ambient air can be used in the oxidation stage 15 instead of the recirculated oxygen. The additional gas permeation separation 19 is then omitted and the gas mixture from stage 18 is released into the environment, with monitoring of pollutants.

Tests of HCl Oxidation with Nitrogen Component:

A supported catalyst was prepared according to the following process. 10 g of titanium dioxide of rutile structure (Sachtleben) were suspended in 250 ml of water by stirring. 1.2 g of ruthenium(III) chloride hydrate (4.65 mmol. Ru) were dissolved in 25 ml of water. The resulting aqueous ruthenium chloride solution was added to the support suspension. The suspension was added dropwise, in the course of 30 minutes, to 8.5 g of 10% sodium hydroxide solution and then stirred for 60 minutes at room temperature. The reaction mixture was then heated to 70° C. and stirred for a further 2 hours. The solid material was then separated off by centrifugation and washed with 4×50 ml of water until neutral. The solid material was then dried for 24 hours at 80° C. in a vacuum drying cabinet and then calcined for 4 hours at 300° C. in air.

0.5 g of the resulting catalyst was used for activity studies in the case of HCl oxidation in the presence of various concentrations of oxygen and nitrogen. The tests were carried out with pure oxygen, with an oxygen and nitrogen mixture (50% O₂) and with synthetic air (20% O₂+80% N₂). The activities have been listed in Table 1.

TABLE 1

| | | | | | Chlorine |
|---|---|---|---|---|---|
| | | | | | conversion |
| | | | | Temperature | (mmol. Cl₂ · |
| | HCl flow | O₂ flow | N₂ flow | reaction bed | min⁻¹ · |
| Test | (l · h⁻¹) | (l · h⁻¹) | (l · h⁻¹) | (° C.) | g(cat)⁻¹) |
| 1 | 2.5 | 1.25 | 0 | 305 | 0.43 |
| 2 | 2.5 | 1.25 | 1.25 | 305 | 0.41 |
| 3 | 2.5 | 1.25 | 5 | 305 | 0.41 |
| 4 | 2.5 | 0.63 | 0 | 306 | 0.24 |
| 5 | 2.5 | 0.63 | 1.25 | 306 | 0.22 |
| 6 | 2.5 | 0.63 | 5 | 306 | 0.22 |

Description of a Test System for Permeation Measurement:

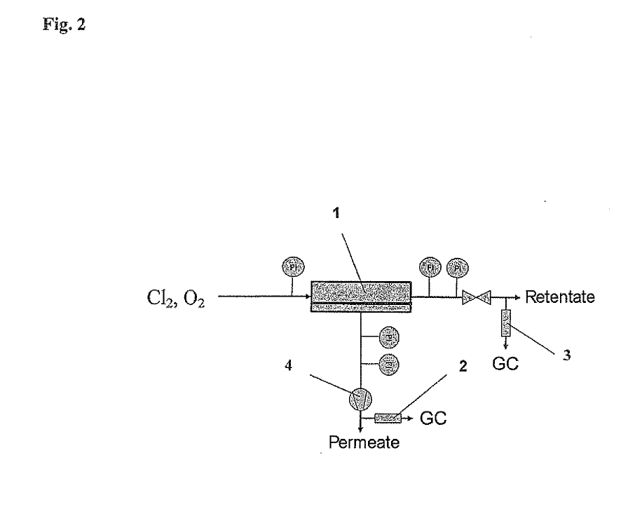

For assessing the efficiency of the membranes, so-called permeation tests using chlorine and oxygen and other minor components are used. The membranes are tested in suitable membrane test cells 1 for carbon membranes and optionally for polymer membranes. FIG. 2 shows the flow diagram of the test apparatus. The feed gas is supplied from compressed gas bottles and is adjusted via flowmeters of the Bronkhorst type. The trans-membrane pressure difference is adjusted either by means of excess pressure on the influx side and/or by connection of a vacuum pump 4 on the permeate side. The permeate flow (m³/m²h) through the membrane is determined with the aid of a flowmeter on the permeate side, by standardisation to the membrane surface area. The gas concentrations are determined by means of sampling 2, 3 by gas chromatography (GC).

Separation of a Chlorine Gas Mixture Using a Carbon Membrane:

A carbon membrane according to M. B. Hägg, Journal of Membrane Science 177 (2000) 109-128, has the following permeabilities:

| | Permeabilities/Nm³/(m²h bar) × 10³ | | | | |
|---|---|---|---|---|---|
| T [° C.] | Cl₂ | O₂ | N₂ | H₂ | HCl |
| 30 | 0.09 | 226.6 | 43.6 | 1769 | 684 |
| 60 | | 220.4 | 51 | 1575 | 795 |
| 80 | | 207.6 | 59.3 | 1465 | 795 |

A gas stream having the following composition:

| | |
|---|---|
| nitrogen | 2909 kg/h |
| oxygen | 2958 kg/h |
| carbon dioxide | 5279 kg/h |
| chlorine | 11111 kg/h, |

a temperature of 30° C. and a pressure of 20.5 bar, is separated into a permeate stream, which has passed through the membrane, and a retentate stream, which remains upstream of the membrane. During this process a pressure of 100 mbar is applied on the permeate side. The membrane surface area used is 6852 ml. The composition of the two resulting product streams is as follows:

permeate:

| | |
|---|---|
| nitrogen | 1874 kg/h |
| oxygen | 2939 kg/h |
| carbon dioxide | 5246 kg/h |
| chlorine | 24 kg/h |

retentate:

| | | |
|---|---|---|
| nitrogen | 1033 | kg/h |
| oxygen | 19 | kg/h |
| carbon dioxide | 33 | kg/h |
| chlorine | 11087 | kg/h |

The oxygen-rich retentate stream can be recycled into the process. The chlorine-rich stream is fed to a chlorine processing plant.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) reacting hydrogen chloride and oxygen to form a gas mixture comprising chlorine, water, unreacted hydrogen chloride, and unreacted oxygen;
(b) cooling the gas mixture to form an aqueous solution of hydrogen chloride;
(c) separating at least a portion of the aqueous solution of hydrogen chloride from the gas mixture;
(d) removing at least a portion of the water from the gas mixture; and
(e) subjecting the gas mixture to a gas permeation such that at least a portion of the unreacted oxygen in the gas mixture is separated to form a chlorine-rich gas stream and an oxygen-containing partial stream.

2. The process according to claim 1, wherein the gas permeation comprises passing the gas mixture through a membrane operating as a molecular sieve.

3. The process according to claim 2, wherein the membrane operating as a molecular sieve has an effective pore size of 0.2 to 1 mm.

4. The process according to claim 1, wherein the gas permeation is carried out with a membrane comprising a material selected from the group consisting of carbon, silicon dioxide, and zeolites.

5. The process according to claim 3, wherein the membrane operating as a molecular sieve comprises a material selected from the group consisting of carbon, silicon dioxide, and zeolites.

6. The process according to claim 1, wherein the gas permeation is carried out at a pressure differential of up to 10⁵ hPa.

7. The process according to claim 5, wherein the gas permeation is carried out at a pressure differential of up to 10⁵ hPa.

8. The process according to claim 1, wherein the gas permeation is carried out at a temperature of up to 400° C.

9. The process according to claim 7, wherein the gas permeation is carried out at a temperature of up to 400° C.

10. The process according to claim 1, further comprising subjecting the oxygen-containing partial stream to a second gas permeation to form an oxygen-rich stream and a waste stream.

11. The process according to claim 9, further comprising subjecting the oxygen-containing partial stream to a second gas permeation to form an oxygen-rich stream and a waste stream.

12. The process according to claim 1, further comprising feeding at least a portion of the oxygen-containing partial stream to the reaction of hydrogen chloride with oxygen to form the gas mixture.

13. The process according to claim 11, further comprising feeding at least a portion of the oxygen-containing partial stream to the reaction of hydrogen chloride with oxygen to form the gas mixture.

14. The process according to claim 10, wherein the second gas permeation comprises passing the oxygen-containing partial stream through a polymer membrane operated in accordance with the solution diffusion principle.

15. The process according to claim 1, wherein the oxygen reacted with hydrogen chloride to form the gas mixture comprises a gas selected from the group consisting of air and air enriched with oxygen.

16. The process according to claim 9, wherein the oxygen reacted with hydrogen chloride to form the gas mixture comprises a gas selected from the group consisting of air and air enriched with oxygen.

17. The process according to claim 15, wherein the oxygen-containing partial stream is discarded.

18. The process according to claim 1, wherein the hydrogen chloride reacted with the oxygen to form the gas mixture comprises a product of an isocyanate preparation process, and at least a portion of the chlorine-rich gas stream is supplied to the isocyanate preparation process.

19. The process according to claim 12, wherein the hydrogen chloride reacted with the oxygen to form the gas mixture comprises a product of an isocyanate preparation process, and at least a portion of the chlorine-rich gas stream is supplied to the isocyanate preparation process.

20. The process according to claim 16, wherein the hydrogen chloride reacted with the oxygen to form the gas mixture comprises a product of an isocyanate preparation process, and at least a portion of the chlorine-rich gas stream is supplied to the isocyanate preparation process.
